(19) United States
(12) Patent Application Publication
(10) Pub. No.: US 2003/0028377 A1
(43) Pub. Date: Feb. 6, 2003

(54) Method and device for synthesizing and distributing voice types for voice-enabled devices

(76) Inventor: Albert W. Noyes, Newton, MA (US)

Correspondence Address: Choate, Hall & Stewart, Exchange Place, 53 State Street, Boston, MA, 02109, US

(21) Appl. No.: 10/151,644

(22) Filed: May 20, 2002

Related U.S. Application Data
(60) Provisional application No. 60/309,253, filed on Jul. 31, 2001.

(51) Int. Cl. G10L 13/00

(52) U.S. Cl. 704/258

(57) ABSTRACT

The present invention discloses a method and device that gives users the ability to select and manipulate specific celebrity voice types into “voice flavors”. Voice flavors can be used with voice-enabled appliances, devices and computer programs, Internet and satellite delivered news services, and other software and hardware applications used in business and/or daily life.

### RELATED APPLICATIONS

The present application claims priority to U.S. Provisional Application No. 60/309,253, filed Jul. 31, 2001, the teachings of which are incorporated by reference herein.

### FIELD OF THE INVENTION

The present invention relates to the field of voice-enabled devices and more particularly to a method and device for synthesizing and distributing recognizable voice types for use with voice-enabled devices.

### BACKGROUND OF THE INVENTION

The pervasiveness of the internet and satellite networks, combined with technology-enabled households, automobiles and a wide variety of other electronic devices and “Internet appliances”, and the increasing adoption of telephony-based applications (such as IVR), is driving the proliferation of voice-enabled applications and, necessarily, synthesized voices.

Although this proliferation is in its early stages, it will only be a matter of time before consumers and businesspeople are frequently able to solicit information from and converse with, in an auditory fashion, everything from their PCs, household appliances and cars to their children's toys and personal information services piped in over satellites and/or household LANs. For example, according to General Electric, which has already developed prototypes of voice-activated appliances, a number of studies indicate that “98 percent of appliances will have computer processing capability and be networked and controlled from remote locations” before 2010. We can expect that many of these appliances will be voice-enabled. In addition, the two leading satellite radio services, Sirius and XM, expect to have several million subscribers in their personalized music and news programs by early 2003.

As synthesized voices become more pervasive, we believe that the audience for these voices will become more sophisticated and demanding. While thus far “natural sounding” synthetic voices have been sufficient, and reflect the commercial state of the art, I believe that there will soon be a demand for synthesizing recognizable, “celebrity” voices in most situations where synthesized voices are used. In this document, it should be noted that the term “celebrity” applies not only to people but to cartoon characters, advertising “spokespeople” and the like, e.g. any voice which is recognizable (or intended to be recognizable) to its audience and attributable thereby to a “named” person, character or brand.

Prior art techniques in the voice synthesis arena have recognized the potential for auditory interfaces, often in a “text to speech” mode. They have also recognized the potential for using voice as a means for interacting with internet applications. For example, U.S. Pat. No. 5,915,001 to Uppaluru entitled “System and Method for Providing and Using Universally Accessible Voice and Speech Data Files” discloses a voice web comprising collections of hyper-linked documents accessible to subscribers using voice commands. U.S. Pat. No. 5,983,184 to Noguchi entitled “Hyper Text Control Through Voice Synthesis” discloses a device that enables a visually impaired user to easily control hyper text via a voice synthesis program that orally reads hyper text on the Internet. The teachings of both of which are incorporated by reference herein.

Finally, prior art techniques have advanced the science of voice synthesis significantly, generally with the goal of increasing the “naturalness” or “personality” of the synthesized voice. For example, U.S. Pat. Nos. 6,334,103 and 6,144,938 both to Surace et al. entitled “Voice user interface with personality” describe a system which delivers a synthetic voice whose “personality” can be described in various “social” and “emotional” terms so that the listener experience is as desired, the teachings of which are incorporated by reference herein.

None of these prior art techniques, however, address the opportunity for providing users with the ability to select a recognizable celebrity voice to be synthesized for a particular application. There is therefore a need for a system that can define, synthesize and distribute specifically selected celebrity voice “types” to a user which can then be used with voice-enabled computers, appliances and devices.

### SUMMARY OF THE INVENTION

The present invention discloses a method and apparatus that gives users the ability to select and manipulate specific celebrity voice types into “voice flavors”. Voice flavors can be used with voice-enabled appliances, devices and computer programs, Internet and satellite delivered news services, and other software and hardware applications used in business and/or daily life.

In one aspect of the invention, the system comprises multiple embodiments for the synthesization and distribution of voice types, including: a methodology for gathering the base level voice flavor components (VFCs) for each desired celebrity voice; a methodology for describing the prosody (e.g. pitch, intensity, tonality, pace/timing and other essential, distinctive characteristics) of a celebrity voice and, when appropriate, certain key phrases the celebrity might be expected to use, tentatively called a Voice Flavor Profile (VFP); a process for combining VFCs with their related VFPs so that the desired type of celebrity voice flavor (VF) is synthesized; a process (voice flavor development kit) for developers to enable any audio application so that it can accept a variety of VFs; and an infrastructure(s) for providing controlled access to a wide range of VFs over the Internet, any other network and/or on accepted storage media (from floppy disks and CDs to chips).

Anticipated audio applications include text-to-speech applications, IVR/telephony applications, web based streaming audio, and personalized news services. Anticipated voice-enabled devices and systems include PCs, IVR applications, GPS systems, navigation systems, automobiles and other transportation vehicles, household appliances, toys, and Internet appliances, among others.

### BRIEF DESCRIPTION OF THE DRAWING

The invention is described with reference to the several figures of the drawing, in which:

FIG. 1 is a schematic diagram of a Voice Flavor selection, distribution and application system according to one embodiment of the invention;

FIG. 2 illustrates the characterization and synthesization of a Voice Flavor according to one embodiment of the invention.

### DETAILED DESCRIPTION OF THE INVENTION

Referring now to the figures of the drawing, the figures constitute a part of this specification and illustrate exemplary embodiments to the invention. It is to be understood that in some instances various aspects of the invention may be shown exaggerated or enlarged to facilitate an understanding of the invention.

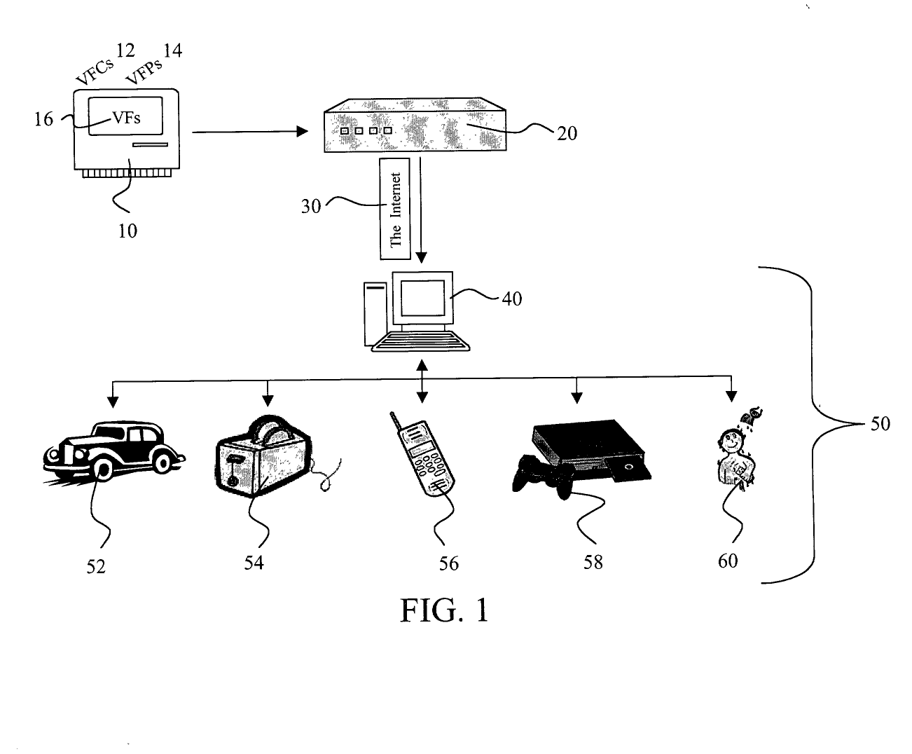

FIG. 1 is a schematic diagram of one embodiment of a Voice Flavor (VF) selection, distribution and application system. A voice flavors database 10 contains a variety of Voice Flavor Components (VFCs) 12 and Voice Flavor Profiles (VFPs) 14 which, when combined, describe the desired VFs 16 and enable them to be synthesized and processed in voice-enabled devices. This database 10 will be accessible from a Voice Flavors web site 20 over the Internet, satellite or other wireless network 30. Once purchased, VFs 16 will be downloaded over the network 30 or delivered on floppy disks, CDs, DVDs, microchips or other storage media and stored by the user on their home computer or other connected computer device 40. The home computer 40 can itself be a voice-enabled device for such applications as e-mail, or the user will be able to select and buy VFs 16 for use with any of a wide variety of voice-enabled devices 50 including automobiles and navigation systems 52, household appliances 54, cell phones and Personal Information Management (PIM) systems 56, games and toys 58 and audio systems (of any form, e.g. in the shower) 60, to name a few examples.

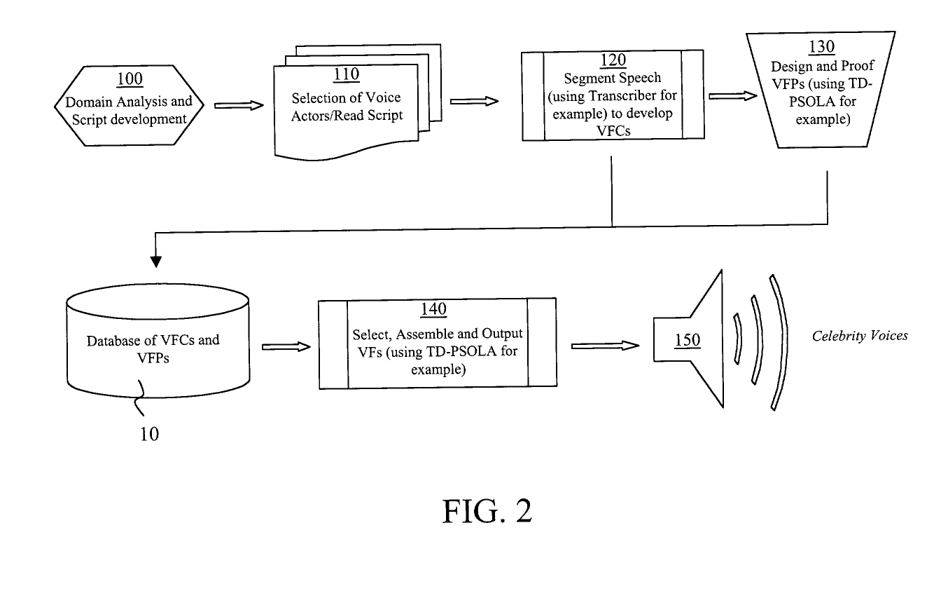

The VFCs 12 and VFPs 14 stored in the voice flavors database 10 can be created through the use of any number of possible voice characterization processes and with varying degrees of complexity and specificity (see, for example, U.S. Pat. Nos. 6,334,103; 6,144,938; 6,014,623; 5,970,453; and 5,915,001, the teachings of which are incorporated by reference herein). In general, the approach to creating a VFC and VFP will be dependent upon the application(s) for which the VF is required and the nature of the source material available. FIG. 2 illustrates one embodiment of the characterization and synthesis process for a VF which is to be used in a well defined and limited domain. Let us also assume that, for this domain, appropriate source material is not readily available. As mentioned above, a VF is generated by applying a VFP to the target VFCs. VFCs are developed in three basic steps.

The first step 100 in VFC development is for an editor to analyze the domain and design a “script” (possibly nonsensical) which, when spoken, will include all of the necessary speech components for synthesizing the dialog required by the domain. In the broadest possible domain, such as a high quality text to speech application capable of processing virtually any text, it would probably be necessary for the editor to design a script which included thousands of these components. For our application, let us assume that the domain only requires 400 components, to be used in a variety of combinations, to generate the vocabulary and phrases/sentences needed. The editor would then design, for example, a script including these 400 components.

The second step 110 is, for each required voice flavor, to select a voice actor, or impersonator, who can mimic the required celebrity and to have him or her read the required script. Of course, if the actual celebrity is available to read the script, or if archival material is available which matches the needs of the domain, even better! This would be done for each celebrity desired. In another embodiment of the invention, it is possible to personalize the creation of the VF to allow for VFs containing distinctive characteristics of the voice type of a user or of the user's friends and family. A user could potentially submit a voice recording to be turned into a voice flavor, or even, as the technology for voice flavors becomes more pervasive, use a program to personally create a voice flavor.

Finally, in the last step 120, the editor applies a software tool, of which there are a number available, the best general purpose algorithm being Transcriber (a free tool for segmenting, labeling and transcribing speech), to disassemble the spoken script and parse it into the desired voice components, or segments. Again, this process would take place for each celebrity desired.

Once the VFCs have been developed for the desired celebrity(ies) in the desired domain, the VFPs must be designed. This is a straightforward iterative process in which the editor must use his or her judgment to determine when sufficient quality has been achieved for each VF.

As a first step in the VFP design process 130, the editor must select a software tool which allows the concatenation of the voice segments contained in the VFC and enables the editor to set prosodic parameters. TD-PSOLA, for example, is a widely available algorithm which will allow the editor to synthesize speech from the VFCs and then fine tune such things as melody, component duration, pace, pitch and intensity until the desired celebrity voice is mimicked with sufficient quality. Having selected such a tool, the editor than concatenates the VFCs targeting sample dialog segments from the desired domain and examines the results for consistency with the celebrity's “sound” and “manner”. As the editor identifies inconsistencies, for example if the synthesized voice is more rapid or high pitched than one would expect the celebrity to sound, the editor adjusts the TD-PSOLA parameters until he/she is satisfied with the results. In addition, the editor can take this opportunity to insert “replacement phrases” which are different ways of saying things which are associated with the desired celebrity. For example, if Bugs Bunny is the VF being programmed, then the editors might specify the words “What's up Doc?” to be used in place of a standard greeting like “Hello”. Similarly, if Clint Eastwood is the VF, then the phrase “Do you feel lucky, punk?” might be specified. In the end, the editor arrives at specified TD-PSOLA settings and some customized scripts which when applied against the file of VFCs to synthesize the celebrity voice in the domain achieve the desired result: a recognizable celebrity voice. The settings and editorial enhancements for this recognizable celebrity voice specify a VFP.

Finally, the process of synthesis requires the programs, such as TD-PSOLA, to engage in a selection step 140 to select the VFCs from its database and use the VFP parameters to generate VF sound files which can be output 150 by the target devices and produce output voice(s) in the sound and manner of the selected celebrity(ies) or other recognizable voice(s). These VF sound files can be output real time or they can be stored in a database accessible to a user by the Internet or other wireless network.

I anticipate that as the technology matures and the applications become more widespread, the process of assembling the VFCs and the characterization processes which result in a VFP and the related audio capabilities of the various VF-enabled devices will become more sophisticated. On one end of the spectrum, for example, in an application whose vocabulary is quite limited (for example, a toaster oven or a toy), a VFP might be developed by having a person(s) read the words and phrases which will be used in the “flavor” that's desired. This is a type of what is known as “waveform encoding.” The device would then simply output the selected voice flavor when audio output was required. Generally, however, the domain/application will require more sophisticated synthesis and processes such as the concatenative one outlined above. Users can access the VFs through “VF”-enabled audio applications which are connected to the Internet and can be incorporated into a voice-enabled device. Anticipated audio applications include text-to-speech applications, IVR/telephony applications, web based streaming audio, and personalized news services. Anticipated voice-enabled devices include GPS systems, navigation systems, automobiles and other transportation vehicles, household appliances, toys, and Internet appliances, among others. Voice-enabled devices could contain the mechanisms for processing and interpreting VFs, such as a VF-enabled audio application, as well as storage means for storing multiple VFs, thus allowing flexibility in the selection of voices for any particular voice-enabled device.

As consumers become accustomed to this pervasive voice communication, they will quickly become bored with the “plain vanilla” synthesized voices common today. There will be a large demand for the ability to personalize a household's voices according to the listener's tastes and the occasion. For example, one might want Clint Eastwood's voice reading news in the morning to prepare for or during a commute, Frank Sinatra's voice in their car's GPS system on a Friday night date with a spouse, and Bugs Bunny in their appliances on a Saturday when the kids are playing at home.

As the technology to characterize the nuances of the various voices improves, VFs can be wholly synthesized to deliver those characteristics through the various Internet-connected audio devices. Until that time, voice “impersonators” and/or previously archived materials could be used to deliver a recognizable approximation of known voices through waveform encoding or concatenative processes as have been described.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A device for synthesizing and distributing voice types, comprising:
at least one voice flavor, wherein said voice flavor comprises at least one synthesized distinctive characteristic of a recognizable voice type;
at least one distribution network adapted to distribute said at least one voice flavor; and
at least one processing device adapted to receive said at least one flavor after distribution and interpret said at least one voice flavor to produce voice information in a sound and manner of said recognizable voice type.

2. The device of claim 1, further comprising:
at least one database adapted to store multiple versions of said at least one voice flavor and adapted to allow access to said multiple versions by said at least one distribution network.

3. The device of claim 1, further comprising:
at least one storage device adapted to store said at least one voice flavor that is distributed to said user from said distribution network.

4. The device of claim 1, wherein said at least one voice flavor is created by a waveform encoding process.

5. The device of claim 1, wherein said at least one voice flavor is created by a concatenation synthesization process.

6. The device of claim 1, wherein said distribution network is selected from the group consisting of: the Internet, wireless networks, storage media, and fiber optic networks.

7. The device of claim 6, wherein said storage media is selected from the group consisting of: a CD-ROM, a magnetic storage device, a floppy disk, and a microchip.

8. The device of claim 1, wherein said synthesized distinctive characteristic is selected from the group consisting of: pitch, tonality, melody, pace, rhythm, component duration, intensity, mannerisms and key phrases.

9. The device of claim 2, wherein said database is selected from the group consisting of: a central database and storage media.

10. The device of claim 3, wherein said at least one storage device is selected from the group consisting of: a CD-ROM, a DVD, a microchip, a hard drive, and a floppy disk.

11. The device of claim 1, wherein saidprocessing device comprises:
at least one voice-enabled device adapted to access said at least one voice flavor and output an audible voice saying at least one selected phrase.

12. The device of claim 1, wherein said voice-enabled device incorporates at least one storage device.

13. The device of claim 11, wherein said voice-enabled device is selected from the group consisting of: household appliances, toys, navigation systems, GPS systems, telephony-based systems, Internet appliances, and transportation vehicles.

14. A method for synthesizing and distributing voice types, comprising the steps of:
creating a voice flavor, wherein said voice flavor comprise at least one synthesized distinctive characteristic of a recognizable voice type;
accessing said voice flavor using a distribution network;
downloading said voice flavor into a voice-enabled device, wherein said voice-enabled device interprets said voice flavor to produce voice information in a sound and manner of said recognizable voice type.

15. The method of claim 14, further comprising the step of:
storing said at least one voice flavor in a database adapted to allow access by said distribution network.

16. The method of claim 14, further comprising the step of:
storing said voice flavor profile on a storage device after downloading from said distribution network.

17. The method of claim 16, wherein said storage device is an integral component of said voice-enabled device.

18. The method of claim 14, wherein said distribution network is selected from the group consisting of: the Internet, wireless networks, storage media, and fiber optic networks.

19. The method of claim 18, wherein said storage media is selected from the group consisting of: a CD-ROM, a DVD, a magnetic storage device, a floppy disk, and a microchip.

20. The method of claim 14, wherein said synthesized distinctive characteristic is selected from the group consisting of: pitch, tonality, melody, pace, rhythm, component duration, intensity, mannerisms and key phrases.

21. The method of claim 15, wherein said database is selected from the group consisting of: a central database and storage media.

22. The method of claim 16, wherein said storage device is selected from the group consisting of: a CD-ROM, a DVD, a microchip, a hard drive, and a floppy disk.

23. The method of claim 14, wherein said voice-enabled device is selected from the group consisting of: household appliances, toys, navigation systems, GPS systems, Internet appliances, and transportation vehicles.

24. The method of claim 14, wherein said voice flavor is created by a waveform encoding process.

25. The method of claim 14, wherein said voice flavor is created by a concatenation synthesization process.
